(19) United States
(12) Patent Application Publication
(10) Pub. No.: US 2017/0102408 A1
(43) Pub. Date: Apr. 13, 2017

(54) Variable Temperature Scanning Tunneling Microscope

(71) Applicants: Kerry W. Hipps, Pullman, WA (US); Abdolreza Jahanbekam, Pullman, WA (US)

(72) Inventors: Kerry W. Hipps, Pullman, WA (US); Abdolreza Jahanbekam, Pullman, WA (US)

(73) Assignee: WASHINGTON STATE UNIVERSITY, Pullman, WA (US)

(21) Appl. No.: 15/287,173

(22) Filed: Oct. 6, 2016

Related U.S. Application Data
(60) Provisional application No. 62/239,745, filed on Oct. 9, 2015.

(51) Int. Cl. G01Q 60/16

(52) U.S. Cl. CPC G01Q 60/16

(57) ABSTRACT

Unique methods and systems are introduced herein that is directed to a new class of Scanning Tunneling Microscope(s) (STM) for Solid Solution (SS) interface studies in which all mechanical components of the STM system are contained in a controlled-temperature and controlled-atmosphere chamber. This new design allows a user to do temperature dependent studies at the SS interface with non-conducting volatile solvents.

### GOVERNMENT INTERESTS

This work was partially funded by National Science Foundation under grants CHE-1058435 and CHE-1112156. The government has certain rights in the invention.

### BACKGROUND OF THE INVENTION

Field of the Invention

The present embodiments herein relate to the field of scanning tunneling microscopy, and more particularly the present embodiments herein relate to the development of systems and methods for the temperature dependent study of physical phenomena at or near a solution-solid interface.

Discussion of the Related Art

Scanning tunneling microscopy (STM) has been widely used to investigate surface structures and electronic properties of adsorbed species on surfaces and also for observing chemical reactions on surfaces. The technique can be used in various environments such as vacuum, air, solution and even under gel. Among these environments, ultrahigh vacuum (UHV)-solid and solution-solid (SS) interfaces get the most attention. If we compare sample preparation procedures for these two environments, it is much easier to prepare samples and take measurements at the SS interface although STM images in UHV generally show higher resolution. If the sample cannot be evaporated without decomposition, SS interface studies may be the only choice.

Generally, studies in UHV require that the molecules of interest be vapor deposited, which is impossible for many compounds. Even in the few cases where the sample is first placed on the substrate from solution, the solvent has to evaporate prior to measurement, thereby introducing the possibility of creating non-equilibrium structures and also observing random results. No matter how the sample is prepared, by the nature of the experiment, UHV studies are not compatible with chemical equilibrium involving material transport to and from the surface. SS interface studies, on the other hand, are easily adaptable to equilibrium studies. In SS studies, one can change the solvent in order to tune molecule-solvent and substrate-solvent interactions at the SS interface, thereby changing the ordering and structure of the adsorbed species. Gyarfas et al. demonstrated that the length of the alkane chain in different alkanoic solvents had a role in determining the surface structure of coronene on gold. Sirtl et al. reported a solvent dependent polymorphism in 1,3,5-tris (4′-biphenyl-4″-carbonitrile) benzene structures in equilibrium with fatty acids. It is even possible to exercise electrochemical control over the formation of adlayers at SS interface. The repair of defects in self-assembled layers at the SS interface can be promoted if there is a dynamic exchange between molecules on the surface and in the solution phase.

Different areas of technology and science profit from temperature dependent SS interface studies. In the area of technology, these studies can yield vital insights into the critical problems in catalysis, spin-casting, friction, crystallization and organic electronics. Temperature dependent studies can yield a great wealth of information including diffusion rates, reaction rates, activation energies and thermodynamic quantities such as entropy and enthalpy of adsorption and/or surface reaction. Because different surface species reach equilibrium at different temperatures, and because some surface reactions are kinetically controlled, a study of a given solution-surface pair as a function of temperature can lead to the discovery of new materials and phases. While STM imaging studies of the SS interface have been going on for 28 years, temperature dependent studies have been rare. Giesen and Baier performed one of the first studies of this kind. Using STM, they studied step fluctuations in metal electrodes in the temperature range of 14° C. to 39° C. Temperature dependent hopping dynamics of various guest molecules in a 2D molecular sieve has been studied by Schull and coworkers. English et al. used ex situ heating of Au (11 1)-coronene-heptanoic acid system up to 105° C. to find a new structure which only formed above 60° C. Marie and co-workers demonstrated that temperature can play a major role in adjusting the density of an adsorbed layer at SS interface. Jahanbekam and co-workers observed several polymorphys of coronene on Au(1 11) in heptanoic acid in the 0° C. to 60° C. temperature range. Friesen et al. have controlled both the temperature and oxygen partial pressure to derive thermodynamic quantities for oxygen binding to cobalt (II) octaethylporphyrin at the phenyloctane/HOPG interface. Bhattarai et al. studied the kinetics of desorption at the SS interface using cobalt and nickel octaetylporphyrin at the phenyloctane/Au (111) interface. Influence of the van der Waals interactions on the structural arrangements of lead pyrenocyanine at the phenyloctane/HOPG interface has been demonstrated by De Feyter's group using a temperature dependent study. De Feyter has used thermodynamic models of STM results to measure enthalpy and entropy changes associated with the phase transitions on surfaces. While these studies show the potential of temperature dependent SS interface STM, the relative infrequency in the literature points to a need in the art for STM systems and methods that better enable a temperature dependent study of physical phenomena at or near a solution-solid interface. The answer can be traced to the imposed limitation(s) by the design of commercial/conventional STM instruments. In particular, commercial/conventional STM instruments commercial/conventional STM instruments and methods of operation for temperature dependent study provides for only the sample being heated, typically by placing the sample for study on a stage that itself is a heating element. While such systems are suitable for the study of solid surfaces in the absence of a solvent, such a configuration and method of heating dramatically limits both the accessible temperature range and solvent type available for temperature dependent study of physical phenomena at or near a solution-solid interface. Even more particular, such a conventional configuration creates an inherent problem of solvent evaporation and resulting multiplayer deposition and/or crystallization at higher temperatures as well as thermal drift in the measurement electronics.

Thus, a need exists in the industry for an STM instrument system and method to address the aforementioned problems. The novel embodiments of the present invention is directed to such a need by providing for methods that utilizes a novel system disclosed herein wherein substantially all of the mechanical components of the system and the sample are heated in a controlled environment at the saturation vapor pressure of the solution under study.

### SUMMARY OF THE INVENTION

It is to be appreciated that the present example embodiments herein are directed to a scanning probe system that includes: a hermetically sealed chamber having an inner space region containing one or more mechanical components of a scanning probe to position a probe in at least one location selected from: at a sample surface location and adjacent a sample surface location; a vacuum system coupled to the sealed chamber to provide a desired pressure within the inner space region; at least one vapor inlet port coupled to the sealed chamber to provide a partial pressure of a vapor within the sealed chamber; a heating and a cooling element configured to control the temperature of an inner space region of the hermetically sealed chamber and contained one or more mechanical components to a temperature of 77° K up to 473° K; a scanner mechanism configured with the scanning probe and adapted along with the scanning probe to provide a tunneling current at one or more points about a sample, and a signal processing circuitry external to the hermetically sealed chamber so as to amplify the tunneling current.

Another aspect of the present application is directed to a method of examining a solution-solid interface that includes: providing a hermetically sealed chamber having an inner space region adapted to removeably receive a scanning probe apparatus and enable equilibration to a desired saturation vapor pressure of one or more solutions; adding a non-conducting solution configured with particles to a solid conducting substrate so as to result in a solution-solid interface; providing one or more desired pressures within the inner space region of the chamber; providing a heating and a cooling element configured to control the temperature; measuring with the scanning probe apparatus, a tunneling current at one or more points about the solution-solid interface; controlling a temperature range via the heating and cooling elements in addition to the one or more provided desired pressures to enable a saturation vapor pressure of the non-conducting solution; and measuring with the scanning probe apparatus, a tunneling current at one or more points about the solution-solid interface.

Accordingly, the methods and systems disclosed herein Unique methods and systems are introduced herein that is directed to a new class of Scanning Tunnel ing Microscope (STM) for Solid Solution (SS) interface studies in which all mechanical components of the STM system are contained in a controlled-temperature and controlled-atmosphere chamber. Such a novel design allows a user to do temperature dependent studies at the SS interface with non-conducting volatile solvents.

### BRIEF DESCRIPTION OF THE DRAWINGS

FIG. 1A shows an example general depiction of the variable temperature scanning tunneling microscope system disclosed herein.

FIG. 1B shows a front view perspective of the controlled-temperature and controlled-atmosphere (hermetically sealed) chamber of the system.

FIG. 1C shows an inside perspective view of a scanning tunneling microscope (STM) within the chamber, as provided by the system of the present application.

FIG. 2 shows a general schematic of an example preamplifier circuitry to be utilized herein.

FIG. 3 shows a plot of the time required to reach a desired temperature from 24° C., and the temperature variation over time inside the chamber 3 for three different temperatures.

FIG. 4 shows the maximum non-linear pixel error as a function of temperature for a Highly Oriented Pyrolytic Graphite (HOPG) sample.

FIG. 5A shows a 30 nm×30 nm STM image of CoOEP at toluene/Au (111) interface at 75.4° C. before XY non-linearity correction, the inset shows the Y pixel error curve before applying correction.

FIG. 5B shows a corrected image for XY linearity, inset shows the Y pixel error curve after applying XY non-linearity correction.

FIG. 6 shows the experimentally observed lattice parameters of HOPG at different temperatures

FIG. 7A shows a corrected 20 nm×20 nm STM images of CoOEP at toluene/Au (111) interface at different temperatures after XY linearization.

FIG. 7B shows a corrected 20 nm×20 nm STM images of CoOEP at toluene/Au (111) interface at different temperatures after XY linearization.

FIG. 8A shows a corrected 20 nm×20 nm STM images resulting in larger bright areas of CoOEP at toluene/Au (111) interface at different temperatures after XY linearization.

FIG. 8B shows a corrected 20 nm×20 nm STM images resulting in larger bright areas of CoOEP at toluene/Au (111) interface at different temperatures after XY linearization.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. It is to be noted that as used herein, the term “adjacent” does not require immediate adjacency. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise.

In addition, unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

### General Description

Embodiments of a system and methods disclosed herein generally includes a hermetically sealed chamber having an inner space adapted to house at least a portion of a scanning probe and the sample to be analyzed, wherein the temperature of the chamber and its contents can be controlled by heating and cooling elements within the hermetically sealed chamber. This configuration enables an unprecedented accessible temperature range from about 77° K up to about 473° K, atmospheric (vacuum through to controlled desired partial is in a range from about 1 Torr up to about 300 Torr of multiple constituents) and temporal (a minute up to hours and weeks) variables for STM systems in general and STM systems for the study of solution-solid interfaces in particular. Embodiments of the hermetically sealed chamber can further be modified to include ports for parallel or serial visual inspection, spectroscopic or electronic inspection of a sample within the chamber. The hermetically sealed chamber can further be configured to serve as an environmental chamber wherein a user can independently modify temperature, pressure (in a range from about 1 Torr up to about 300 Torr) and atmospheric conditions within the chamber and preform STM measurements under conditions inaccessible with conventional instrumentation.

The system disclosed herein serves to broaden both the accessible temperature range and solvent type available for temperature dependent study of physical phenomena at or near a solution-solid interface. In certain embodiments, the atmospheric conditions within the chamber can be tailored to maximize the temperature range over which a particular SS system can be studied. As a non-limiting example for a given solvent, the internal portion of the hermetically sealed chamber can be maintained at the saturation vapor pressure for a given solvent at a given temperature, thus eliminating solvent evaporation at the sample thereby dramatically extending not only the accessible temperature window for a given solvent but also the potential temporal duration of a given experiment. Due to solvent evaporation, conventional systems lacking environmental control do not allow for elevated temperature and extended duration experiments involving a solvent. In yet further embodiments, the atmospheric conditions within the sealed chamber can be utilized to introduce or eliminate volatile components into a SS system. As a non-limiting example for a given SS system, the partial pressure(s) of volatile solvents within the hermetically sealed chamber can be utilized to controllably modify the solution conditions of the sample.

### Specific Description

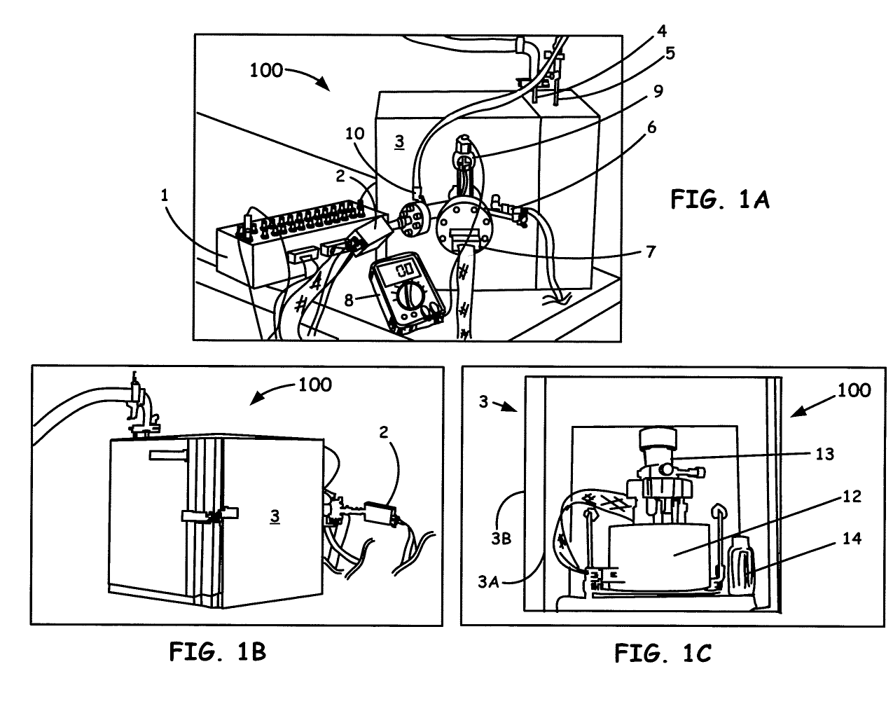

Turning now the drawings, FIG. 1A, FIG. 1B and FIG. 1C illustrate an exemplary non-limiting embodiment(s) of a variable temperature scanning tunneling microscope, as constructed in accordance with the teachings herein. The example system shown in FIG. 1A and as generally referenced by the numeral 100, includes components, such as, a signal access module 1, a signal processing circuitry 2 (e.g., a signal preamplifier module) so as to amplify desired tunneling current and of which is arranged in a novel fashion external to a hermetically sealed chamber 3. Additional components include a first port 4 for evacuating the hermetically sealed chamber 3, a second port 5 for introducing desired one or more gases into the chamber 3, an outlet 6 for fluid cooling, a communication interface 7 (e.g., a ribbon communication cable) between the scanning tunneling microscope 12 (as shown in FIG. 1C) and a controller (not shown), a temperature reading means 8, such as, but not limited to a digital voltmeter for reading thermocouple temperature provided by, for example one or more thermocouple connection ports 9, and, an inlet 10 for fluid cooling.

FIG. 1B shows a front and inside perspective view of the controlled-temperature and controlled-atmosphere (hermetically sealed) chamber 3 and coupled processing circuitry 2 of system 100. FIG. 1C shows an inside perspective view of a scanning tunneling microscope (STM) 12 and a solution reservoir 14 within the chamber, as provided by system 100.

It to be noted that while a controller is not explicitly shown FIG. 1A, it is to be emphasized that the operation of components within system 100 or any other embodiment disclosed herein can equally be enabled by a controller and data system of various circuitry of a known type. Such a control and data system can thus be in the form of a desktop computer, a laptop computer a network server, a server computer, or can be implemented by any one of or a combination of general or special-purpose processors (digital signal processor (DSP)), firmware, software, and/or hardware circuitry to provide instrument control, data analysis, etc., for the example configurations disclosed herein.

Individual software modules, components, and routines may also often be utilized by system 100, as shown in FIG. 1A, FIG. 1B, and FIG. 1C in the form of a computer program, procedure, or process written in a suitable programming language, e.g. C, C#, C++. In addition, the computer programs, procedures, or processes may be compiled into intermediate, object, or machine code and presented for execution as instructions and control functions, so as to be implemented by system 100, as shown in FIG. 1A, FIG. 1B, and FIG. 1C, or any other configurations disclosed herein. Various implementations of the source, intermediate, and/or object code and associated data may also be stored in one or more computer readable storage media that include read-only memory, random-access memory, magnetic disk storage media, optical storage media, flash memory devices, and/or other suitable media. As used herein, the term “computer readable storage media” excludes propagated signals, per se and refers to media known and understood by those of ordinary skill in the art, which have encoded information provided in a form that can be read (i.e., scanned/sensed) by a machine/computer and interpreted by the machine's/computer's hardware and/or software.

### Instrument Design

The STM system 100, as shown in FIG. 1A, FIG. 1B, and FIG. 1C is constructed using an integrated controlled-atmosphere and controlled-temperature chamber 3. Such a system includes a signal processing module 2 (e.g., a preamplifier), It is to be noted that a substantial number, but not all, of the mechanical/electrical parts of the STM system 100 are positioned inside the chamber, as generally shown in FIG. 1C. This new design moves the signal processing circuitry 2 (preamplifier), as shown in FIG. 1B, required for sensitive STM studies from its conventional position (i.e., permanently mounted to the STM 12 head 13 where it can easily be damaged by exposure to solvent vapor and or temperature) to the exterior of the heated chamber 3, as shown in FIG. 1B, where it operates under ambient conditions. The following sub-sections describe the specifications of different parts of the novel STM system 100.

### Integrated Controlled-Atmosphere and Controlled-Temperature Chamber

As part of the temperature capabilities of the present application, the chamber 3, as stated above, can be heated to a temperature range from about 77° K up to about 473° K, atmospheric (vacuum through to controlled partial pressures of multiple constituents) and temporal (hours to weeks) so thermal drift needs to and is addressed by the configurations herein. Thermal drift in STM 12 microscopes itself arises from the difference in temperature between the STM head 13 and the sample (not shown). Thus, as presented herein, if the entire STM microscope 12 is surrounded in a controlled temperature environment (i.e., by chamber 3), a substantial amount of the thermal drift is eliminated.

To illustrate an example working embodiment of the present application, a chamber 3, as shown in FIG. 1A, FIG. 1B, and FIG. 1C, configured as a vacuum oven can be customized or configured from a commercial unit, such as a reconfigured Hamilton Instrument repurposed for the embodiments herein. The inner wall e.g., 3A as shown in FIG. 1C, of this example oven configuration, is desirably, but not necessarily, constructed from a metal, such as, but not strictly limited to, aluminum, and for the example embodiment shown in FIG. 1A, FIG. 1B, and FIG. 1C, the example inner wall 3A thickness is about a ⅜″ aluminum plate. It is to be appreciated the design to include the inner wall 3A enables for vacuum tight operation, often by welding the chamber 3 to provide such a capability and by utilizing sealing techniques, such as, for example, by using vacuum structures, e.g., vacuum grooves, that can contain insulating materials having beneficial known chemical and physical properties that are resistant to various organic solvents. Example materials include Fluorocarbon Rubber type O-rings, such as, Viton® and Kalrez®, as such materials have high temperature stability and good resistance to chemicals and ozone.

The outer wall 3B, as shown in FIG. 1C, is also made of a metal, such as, but not limited to steel. The chamber 3 itself, when in operation, is thus often heated up to about 200° C. The floor (not denoted) of the chamber can be fitted with heat exchangers known in the art for the example embodiments herein. Preferably, the floor of the chamber 3 is fitted with with a copper block heat exchanger so as to enable a user to cool down the chamber using a coolant enabled to flow through prescribed portions of chamber 3 using inlet 9 and outlet 6.

The outer wall 3B, as shown in FIG. 1C, is also made of a metal, such as, but not necessarily limited to steel. The chamber 3 itself, as part of operation, can be heated up to about 200° C. The floor (not denoted) of the chamber utilizes heat exchangers known in the art but for the example embodiments herein, the floor of the chamber 3 can often be fitted with a copper block heat exchanger so as to enable a user to cool down the chamber with cooling techniques, such as with fluid cooling. Such an arrangement shown herein thus enables the system 100 to stabilize from temperatures ranging from −5° C. up to 200° C. In order to provide electrical access under low noise and controlled conditions, a conduit, often a stainless steel conduit (e.g., a tube, preferably a stainless steel tube of a desired inside diameter) is coupled to the back of the chamber and several flanges (e.g., Ultra high vacuum flanges (UHV)) are integrated with the tube, such as by welding methods known in the art. Such an arrangement enables electrical connections mounted on high temperature UHV flanges to be joined with gaskets, often copper gaskets. All wires are also insulated, using for example, Kapton insulation.

When the chamber is heated, the solvents evaporate and this, inevitably, will end up with coating all exposed areas in the chamber. The need for cleaning up prior to reuse of the system can be difficult and time consuming. Moreover, it is often desirable to eliminate oxygen or water vapor from the chamber. Thus, the chamber can be evacuated with a vacuum apparatus, such as a scroll vacuum pump. A scroll pump is used to eliminate possible pump oil contamination of the chamber. K-type thermocouples are mounted onto the floor of the chamber and onto the STM in order to monitor the temperature of the system. Temperature controllers (e.g., a CNi8C PIO temperature controller) are utilized for the configurations herein and are coupled with a solid state relay known in the art, such as, but not limited to, a SSRL240DC10 solid state relay from OMEGA. The area between the inner chamber and the outer wall was is more often insulated with glass wool to ensure minimal heat loss to/from the surroundings. Valved ports for introducing inert gasses and for flushing and evacuating the inner chamber are often added. A means for measuring the pressure, e.g., a capacitance manometer (not shown) is utilized to monitor the chamber pressure.

FIG. 1C shows an open solution reservoir 14 much greater in volume than a sample volume (not shown) provided in the chamber 3. It is to be appreciated that since the reservoir 14 can be held at the same temperature as the sample, there is no net solvent evaporation from the sample. This solves the problem of solvent evaporation and resulting multilayer deposition and/or crystallization at higher temperatures. It is desirable that the solution in the reservoir 14 match the composition of the solution in the sample cell (not shown). If only solvent is used, the concentration of the sample solution decreases with increasing temperature (e.g., osmotic pressure effect).

### STM System

For an STM base 12 for the system 100 utilized herein, in order to drive the course approach mechanism, an ultra-high-vacuum stepper motor (e.g., at least 200 steps per revolution) is utilized that is designed to withstand temperatures of up to 175° C. The STM 12 , 13 is thus controlled by a custom or commercial Digital Instruments controller (e.g., Bruker) manipulated by commercial (e.g., Nanoscope) and/or custom software. The scanner utilized herein eliminates the local preamp and allow low noise and low capacitance connection to a SMA coupled coaxial cable. This coax connected to a UHV compatible BNC bulkhead connecter and from there to a custom pre-amplifier 2. The scanner enables scan areas of up to 1.1 μm. Scan times is often in the order of one minute (the time between consecutive scans) with the longest timescale being on the order of days to weeks (while maintaining the sample and chamber). To interface the pre-amplifier 2 with the system controller (not shown), a signal access module 1 (break-out box) is used.

### Pre-Amplifier

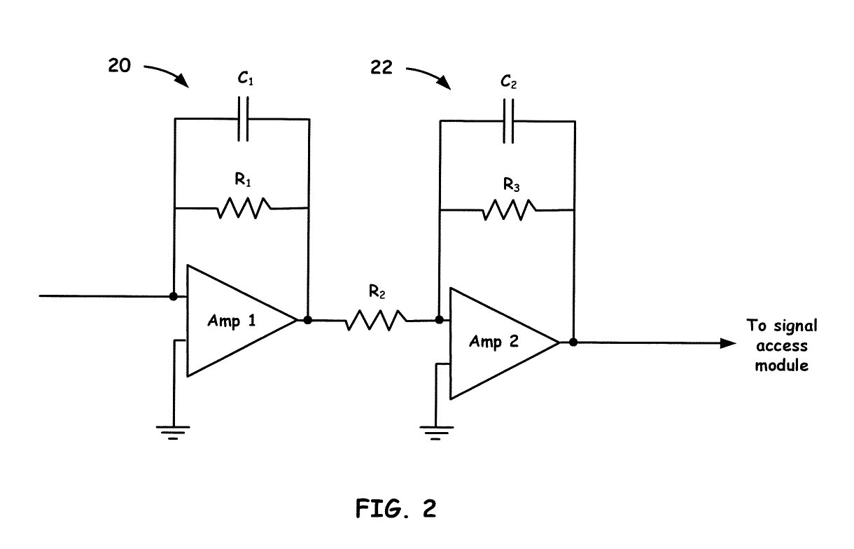

An issue associated with heating the entire microscope 12, 13 including the preamplifier 2, is the conversion from tunneling current to voltage. In particular, this issue arises from the fact that operational amplifiers have finite operating temperature ranges and often shown significant leakage current changes with temperature. The solution herein to overcome this issue and of which is a non-obvious modification, is to house the pre-amplifier 2 externally (e.g., see FIG. 1B), but configured to be as close as possible to the chamber 3. In common STM applications, the tunneling bias is of the order of 1V and the tunneling current is of the order of 0.1 nA. This yields a source impedance of more than 1 GΩ. Such large source resistances are best handled by keeping the current wires from tunneling junction to the pre-amplifier 2 well shielded and as short as possible. For the purpose of limiting the input current noise as well as the input offset error, an amplifier, such as, for example, an FET operational amplifier with low bias current and high input impedance is often designed into the system 100. An example operational amplifier capable of being utilized herein is an OPA211 operational amplifier, which is a high precision monolithic dielectrically isolated FET op-amp. Because of such a non-obvious design consideration (e.g., externally mounted and close to chamber 3), the resultant preamplifier 2 herein thus had a surprising and unexpected final current sensitivity of at least 1 nA/V. FIG. 2 thus shows an example configuration of the preamplifier circuitry 2 utilized herein. The example preamplifier 2 comprises two stages. The first stage 20 is configured to operate as a current to voltage converter and the second stage 22 is configured to amplify the voltage from the first stage.

### System Properties

### A. Temperature Stability

Thermal drift is defined as time-dependent relative movement between the tip and the surface of the sample which arises due to the present of temperature gradients and transients in the instrument components. Using a controlled chamber 3, in which the entire STM 12, 13 mechanism is held at a constant temperature, significantly reduces thermal drift in the measurement. The extent to which temperature is stable is reflected in the amount of thermal drift observed.

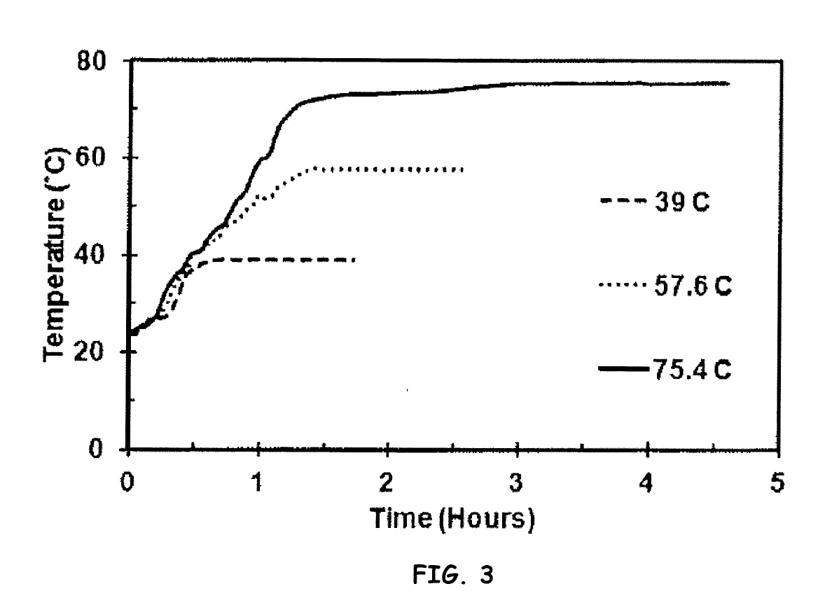

FIG. 3 shows a plot of the time required to reach a desired temperature from 24° C., and the temperature variation over time inside the chamber 3 for three different temperatures, i.e., 39° C., 57.6° C. and 75.4° C. Beneficial results determined that the temperature variation is less than or equal to +/−0.1 over the 39° C. to 75° C. range. Such a plot is enabled via a thermocouple configured to the floor of the chamber 3.

### B. Scanner Linearity and Temperature

One of the very important qualities of a good scanner is its linear behavior during the scanning process. Linearity implies that the amount of movement of the scanner is exactly proportional to the applied voltage. It is to be appreciated that while calibrating the temperature dependence of the STM, as further detailed below, it was observed that the amount of non-linearity in the image was increasing with increased temperature.

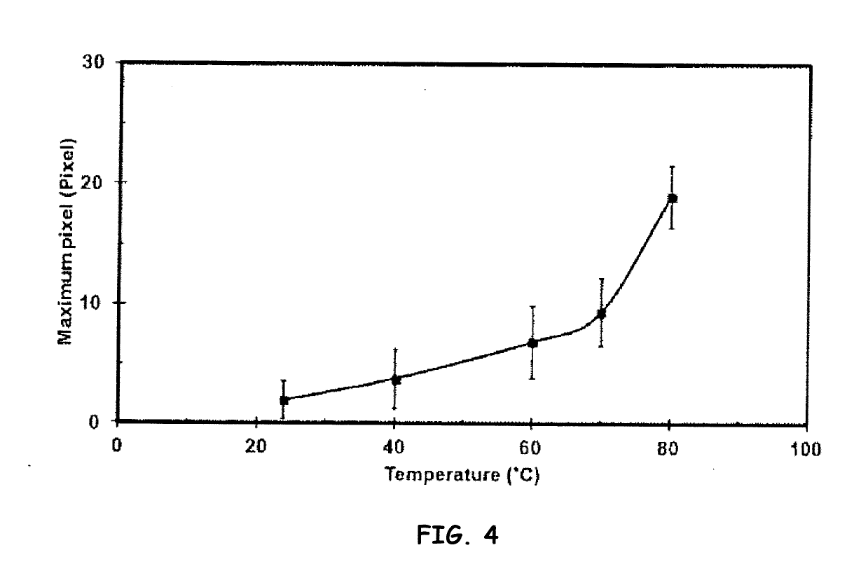

FIG. 4 shows the maximum non-linear pixel error as a function of temperature for a Highly Oriented Pyrolytic Graphite (HOPG) sample. Software analysis enabled quantifying XY linearity in the images and errors so as to be capable of being visualized as scatter plots for each X and Y position in pixel units. It is apparent from the curve that the amount of non-linearity in the images is increasing with increasing temperature. The software also enables users to correct the non-linearity of the image by using the pixel location error data.

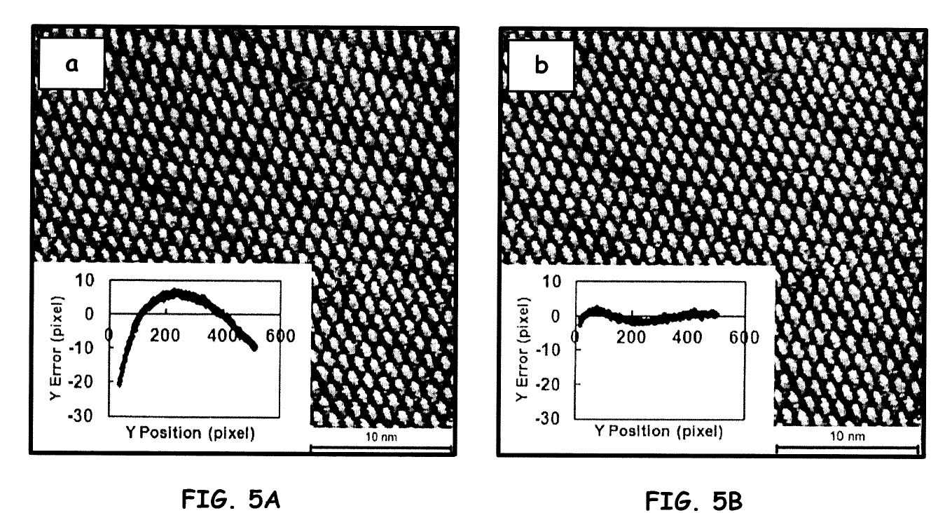

FIG. 5A (also denoted as (a)) shows an unmodified raw image of cobalt octaethylporphyrin (CoOEP) at the toluene/Au (111) interface at 75.4° C., as provided by the embodiments herein. The image has considerable non-linearity. FIG. 5B (also denoted as (a)) shows the same image after applying the XY non-linearity correction. The non-linearity is also identifiable from the linearity error curve in the inset of the image shown in FIG. 5A. The inset is Y pixel errors as a function of Y position. It is clear from the inset to FIG. 5B that the amount of non-linearity is considerably decreased after applying the XY non-linearity correction. To assure that XY non-linearity correction procedure is not distorting the lattice constants, the following procedure can be performed. In particular, 15 nm×15 nm images are cut from the middle part of the uncorrected 30 nm×30 nm images (where the amount of non-linearity in the image was minimal). Then, the lattice parameter values of the cut images are compared with the values of the linearity corrected image. These lattice parameter values are shown very close to each other.

### C. Scanner Sensitivity and Temperature

Scanners for SPM applications are made of piezoelectric materials. Their critical materials property is the piezoelectric strain coefficient. This coefficient describes the relationship between the applied electric field and the mechanical strain produced. The “scanner sensitivity” is the relationship between applied voltages and induced mechanical movements in the tip attached to the scanner. Unfortunately, the magnitude of the piezoelectric coefficient is temperature dependent. In order to provide accurate distances in a variable temperature STM, the scanner sensitivity is determined as a function of temperature. The present embodiments utilized Highly Oriented Pyrolytic Graphite (HOPG), as mentioned above, as a reference. It is an exemplary candidate for this task because of its well defined hexagonal lattice system with known unit cell spacing. Further, the coefficient of thermal expansion along the layer plane direction is of the order of −1×10⁶° C.¹. Thus, the difference between the lattice parameters of HOPG at 22° C. and 80° C. is less than 7×. Thus, the difference between the lattice parameters of HOPG at 22° C. and 80° C. is less than 7×10⁶ 10^{0.5} Å, which is negligibly small. By comparing the measured lattice parameters at different temperatures with the known value of 2.46 Å, correction factors to the scanner sensitivity of the present embodiment are capable of being obtained.

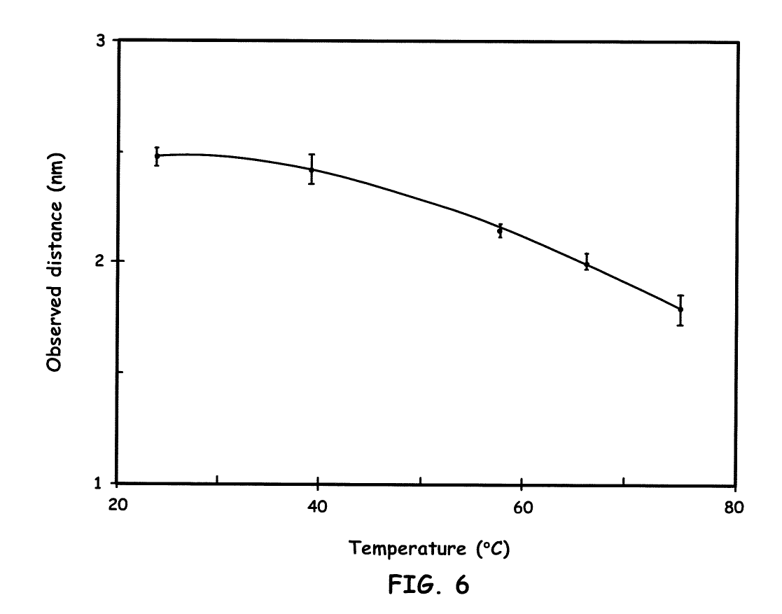

FIG. 6 shows the experimentally observed lattice parameters of HOPG at different temperatures to provide raw uncorrected values. Thereafter, as shown in Table 1 below, the correction values to be utilized are obtained by dividing the actual lattice spacing (e.g., 0.246 nm) by the observed values.

TABLE I
Correction factors for scanner sensitivity correction

| | Correction Factor |
|---|---|
| Temperature (° C.) | (reference value/measured value) |
| 23.9 | 1 |
| 3.9 | 1.02 |
| 57.6 | 1.15 |
| 66.2 | 1.23 |
| 75.4 | 1.38 |

The present invention will be more fully understood by reference to the following, which is intended to be illustrative of the present invention, but not limiting thereof.

### EXAMPLE

### CoOEP at the Toluene/Au (111) Interface

To demonstrate the performance of the instrument, a temperature dependent study of cobalt(II) octaethylporphyrin (CoOEP) adsorbed on Au (111) at the toluene/Au (111) interface has been performed. CoOEP was purchased from Aldrich and used as supplied. Toluene was >99%. Au (111) films with well-defined terraces were epitaxially grown on mica and were about 0.12 μm thick. The gold films were annealed with a hydrogen flame just prior to use. A stock solution of CoOEP dissolved in toluene was prepared with a concentration of 2×10⁻⁴. STM samples were fabricated by placing a 15 μL droplet of solution directly on the gold surface. Both etched and cut Pt _{0.8} Ir_{0.2} tips were used. Typical settings were adjusted to give a sample bias of −0.5V, a tunneling current of 50 pA, and a scan rate of 7.63 Hz. An open solution reservoir of 2×−4 CoOEP in Toluene was used to ensure solvent vapor pressure equilibration. Toluene was an exemplary but not limiting solvent chosen due to its volatile nature (boiling point at 111° C.). It is to be noted and appreciated that it is not possible to do temperature dependent studies with such solvents at high temperatures with conventional STM instruments. This is one of the many novel aspects of the present application and resulting embodiments. In fact, it takes less than 5 minutes for a 15 μL, droplet of toluene to totally evaporate from a gold surface at 40° C. Table II below shows the lattice parameters at CoOEP at the toluene/Au (111) interface at different temperatures while Table III shows a non-exhausting list of example solvents and associated boiling points capable of being utilized by the embodiments herein.

TABLE II
Lattice parameters at CoOEP at the toluene/Au (111)
interface at different temperatures

| | Lattice Parameters | | |
|---|---|---|---|
| Temperature (° C.) | A (nm) | B (nm) | α (°) |
| 23.9 | 1.33 +/− 0.04 | 2.48 +/− 0.04 | 96 +/− 2 |
| 39.0 | 1.34 +/− 0.04 | 2.52 +/− 0.04 | 98 +/− 2 |
| 57.6 | 1.38 +/− 0.04 | 2.50 +/− 0.04 | 96 +/− 2 |
| 75.4 | 1.39 +/− 0.04 | 2.53 +/− 0.04 | 97 +/− 2 |

TABLE III
Solvent list

| | Solvent | Boiling point |
|---|---|---|
| 1 | Benzene | 80° C. |
| 2 | Toluene | 110° C. |
| 3 | Cyclohexane | 80° C. |
| 4 | Heptylbenzene | 230° C. |
| 5 | Octylbenzene | 264° C. |
| 6 | Heptane | 98° C. |
| 7 | Octane | 125° C. |
| 8 | Carbon tetrachloride | 76.3° C. |
| 9 | Heptanoic acid | 223° C. |
| 10 | Octanoic acid | 237° C. |
| 11 | Ethanol | 78° C. |

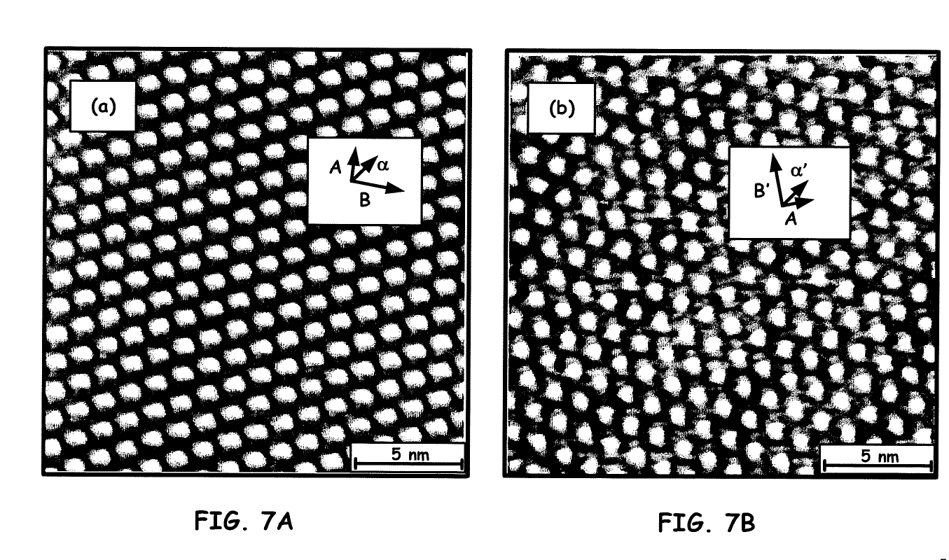

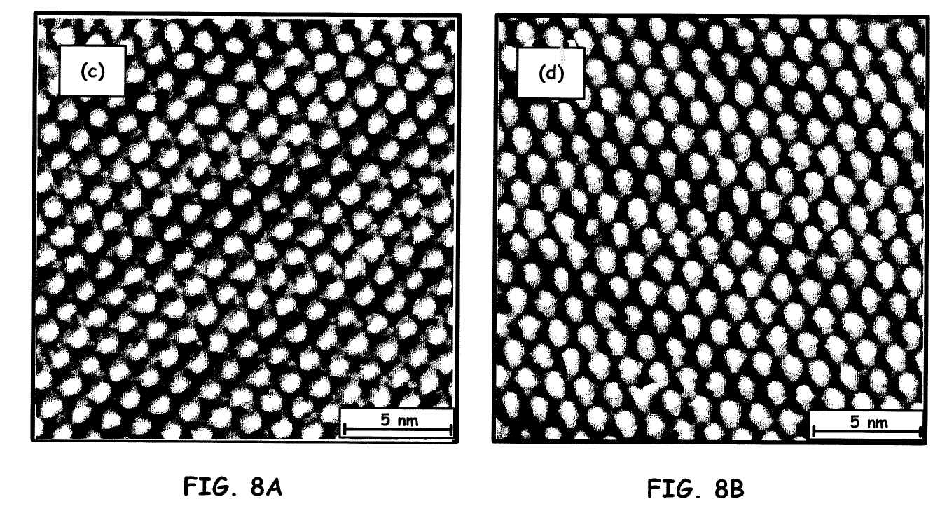

FIG. 7A (also denoted by inset (a)), FIG. 7B (also denoted by inset (a)), FIG. 8A (also denoted by inset (c)), and FIG. 8B (also denoted by inset (d)) show corrected 20 nm×20 nm STM images of CoOEP at toluene/Au (111) interface at different temperatures after XY linearization that correspond to values listed in Table II above.

The temperatures were read using a thermocouple configured at the floor of the chamber 3 of system 100, as shown in FIG. 1A, FIG. 1B and FIG. 1C, as described above. Corrections were obtained as follows. STM images were background subtracted and then XY linearity was analyzed and corrected using software. Then images were corrected for small drifts with a linear drift correction algorithm. The last part of the procedure was correction for the scanner sensitivity. All of the data processing procedures were performed using software (e.g., SPIP software). Then, lattice parameters for CoOEP at the toluene/Au (111) was measured as shown in Table II above.

FIG. 7A, FIG. 7B, FIG. 8A, and FIG. 8B thus show images which are all of good quality. Differences in appearance are due primarily to differences in contrast and the sharpness of the tip when the image was measured. With a very sharp tip, only the region immediately near the cobalt ion appears (see FIG. 7B (also denoted by inset (b)). Less sharp tips result in larger bright areas, as in FIG. 8A (also denoted by inset (c)) and FIG. 8B (also denoted by inset (d)). It is also possible that there in increased lateral motion (frustrated translation) on the surface at higher temperatures. What is known is that the CoOEP does not fully desorb from gold at temperatures below about 100 C into phenyl octane, a solvent very similar to toluene.

As is indicated in Table II, the lattice parameters remain constant within the experimental error throughout the studied temperature range by the embodiments herein. The averaged lattice parameters were: A=(1.36±0.04) nm and B=(2.51±0.04) nm with a value of 97°±220 for the defined unit cell in the FIG. 7A which comprises a body centered cell with two molecules per unit cell. Those skilled in the art defined a unit cell consisting of one molecule of CoOEP at Phenyloctane/Au (111) interface. For this cell the skilled artisan found lattice parameters to be: A′=(1.32±0.02) nm, B′=(1.42±0.02) nm, and a′=57°±2°. For the same cell (shown in FIG. 7(b)), the results herein were A′=(1.36±0.04) nm and B′=(1.49±0.04) nm with a′=55°±2°. These values are in good agreement. The choice of one or two molecules per unit cell cannot be made solely on the images presented here. For the resolution provided, all the surface molecules look the same. For NiOEP on Au (111) in UHV, however, one can clearly see two different molecular orientations in a unit cell containing two molecules. As a body centered cell, NiOEP/Au (111) in UHV has A=(1.38±0.04) nm, B=(2.78±0.08) nm, and a=99°±3° C.

It is to be understood that features described with regard to the various embodiments herein may be mixed and matched in any combination without departing from the spirit and scope of the invention. Although different selected embodiments have been illustrated and described in detail, it is to be appreciated that they are exemplary, and that a variety of substitutions and alterations are possible without departing from the spirit and scope of the present invention.

We claim:

1. A scanning probe system, comprising:
a hermetically sealed chamber having an inner space region containing one or more mechanical components of a scanning probe to position a probe in at least one location selected from: at a sample surface location and adjacent a sample surface location;
a vacuum system coupled to the sealed chamber to provide a desired pressure within the inner space region;
at least one vapor inlet port coupled to the sealed chamber to provide a partial pressure of a vapor within the sealed chamber;
a heating and a cooling element configured to control the temperature of an inner space region of the hermetically sealed chamber and contained one or more mechanical components to a temperature of 77° K up to 473° K;
a scanner mechanism configured with the scanning probe and adapted along with the scanning probe to provide a tunneling current at one or more points about a sample, and
a signal processing circuitry external to the hermetically sealed chamber so as to amplify the tunneling current.

2. The scanning probe system of claim 1, wherein the scanning probe is a scanning tunneling microscope.

3. The scanning probe system of claim 1, wherein the sample is a solid surface covered by a non-conducting volatile solution.

4. The scanning probe system of claim 3 wherein the non-conducting volatile solution is selected from: Toluene, Benzene, Cyclohexane, Heptylbenzene, Octylbenzene, Heptane, Octane, Carbon tetrachloride, Heptanoic acid, Octanoic acid, Ethanol, and Octane.

5. The scanning probe of claim 3, wherein the vapor is the same composition as the non-conducting volatile solution.

6. The scanning probe of claim 3, wherein the vapor comprises a composition distinct from the non-conducting volatile solution.

7. The scanning probe of claim 1, wherein a voltage applied to a piezoelectric material configured with the scanning probe provides a given displacement dependent on the temperature of the system.

8. The scanning probe of claim 1, wherein the scanning probe system further comprises a pre-amp external to the hermetically sealed chamber so as to amplify the tunneling current.

9. A scanning probe method of examining a solution-solid interface, comprising:
providing a hermetically sealed chamber having an inner space region adapted to removeably receive a scanning probe apparatus and enable equilibration to a desired saturation vapor pressure of one or more solutions;
adding a non-conducting solution configured with particles to a solid conducting substrate so as to result in a solution-solid interface;
providing one or more desired pressures within the inner space region of the chamber;
providing a heating and a cooling element configured to control the temperature;
measuring with the scanning probe apparatus, a tunneling current at one or more points about the solution-solid interface;
controlling a temperature range via the heating and cooling elements in addition to the one or more provided desired pressures to enable a saturation vapor pressure of the non-conducting solution; and
measuring with the scanning probe apparatus, a tunneling current at one or more points about the solution-solid interface.

10. The method of claim 9, wherein the non-conducting solution is a volatile solution.

11. The method of claim 10, wherein the non-conducting solution is a volatile solution selected from: Toluene, Benzene, Cyclohexane, Heptylbenzene, Octylbenzene, Heptane, Octane, Carbon tetrachloride, Heptanoic acid, Octanoic acid, Ethanol, and Octane.

12. The method of claim 9, wherein the method further comprises of: providing scan times of down to a minute.

13. The method of claim 9, wherein the measuring step further comprises:
measuring lattice parameters of a known calibration sample over the temperature range;
correcting a scanner sensitivity of the scanning probe apparatus across the controlled temperature range using the measure lattice parameters.

14. The method of claim 9, wherein the measuring step further comprises:
correcting a non-linearity of the scanning probe apparatus via pixel location error data.

15. The method of claim 9, wherein the one or more desired pressures is in a range from 1 Torr up to 300 Torr.
